(19) United States
(12) Patent Application Publication
(10) Pub. No.: US 2006/0264292 A1
(43) Pub. Date: Nov. 23, 2006

(54) Gearbox device

(76) Inventor: Klaus Plath, Muelsen (DE)

Correspondence Address: Striker Striker & Stenby, 103 East Neck Road, Huntington, NY, 11743, US

(21) Appl. No.: 10/550,048

(22) PCT Filed: Mar. 25, 2004
(86) PCT No.: PCT/DE04/00643

§ 371 Date: Jul. 3, 2006

(30) Foreign Application Priority Data
Mar. 25, 2003 (DE) 103 14 069.7
Mar. 2, 2004 (DE) 10 2004 010 654.1

(51) Int. Cl. F16H 1/32

(52) U.S. Cl. 475/162

(57) ABSTRACT

In particular a planetary gear system is described which, as usual, has a sun wheel (1), a ring gear (2) and at least one planet wheel (9). According to the invention, the planet wheel (9) is rotatably mounted on a bearing axle (10) which is provided with a power transmission axle (12) intended for the input or output of power and arranged eccentrically with respect to the central axis (8) of the planet wheel (9). The same arrangement is also described for a gearbox device which has two parallel, linear tracks (61, 62) instead of the sun wheel and ring gear (1, 2).

The invention relates to a gearbox device of the type quoted in the preamble of claim 1.

Gearbox devices of this type are generally designed as planetary gear systems (e.g. Johannes Looman “Grundlagen, Konstruktionen, Anwendungen in Fahrzeugen”, 3^{rd} edition, volume 26; Herbert W. Muller “Die Umlaufgetriebe”, Berechnung, Anwendung, Auslegung, volume no. 28). In their simple structure, they have a first moveable track in the form of the outer perimeter of a sun wheel, a second moveable track in the form of the inner casing of a ring gear surrounding the sun wheel and at least one planet wheel which is arranged between these tracks and is rotatably mounted on a planet carrier (web). The planet wheel is in operative connection at its perimeter both with the sun wheel and with the ring gear, this operative connection being here understood for example as meshing (toothed wheel gear system) or a rolling arrangement (friction gear system) and is rotatably mounted on a bearing axle which is simultaneously a power transmission axle, and can circulate on a third track arranged between the two tracks. The planet wheel is supported and guided by a carrier element between the track, which is formed by the outer perimeter of the sun wheel, and the track which is formed by the inner casing of the ring gear.

The three mentioned tracks are in planetary gear systems concentric or coaxial circular tracks at strictly prescribed spacings. However they can also have a linear or arcuate shape, also with constant spacings between one another and in a parallel arrangement.

Gearbox devices of this type are also described as three-shaft gear systems, especially as three-shaft planetary gear systems. In contrast to corresponding gearbox devices in which in each case one of the tracks is arranged stationary and is for example designed as a fixed component of a gearbox housing, three-shaft gear systems of the type of interest here have no fixed track, i.e. the sun wheel, ring gear, planet wheel and power transmission axle are mounted so as to be moveable, such that in each case two shafts can be used for driving and one shaft for power take-off or conversely two shafts can be used for power take-off and one shaft for driving.

The power transmission in the region of the carrier element or web takes place in the known gearbox devices independently of whether it is used as a drive or power take-off element of the gear system, always via the bearing axle located in the centre of the planet wheel and around which the planet wheel is rotatably mounted on the carrier element. Thus bearing axle and power transmission axle coincide. In addition to guiding the planet wheel axle, the web is also used for power transmission.

In planetary gear systems of the type described, the tracks on which the bearing axle and the power transmission axle move are at the same constant spacing from the centre axis of the sun wheel, this spacing being equal to the sum of the sun wheel radius and the planet wheel radius. As a result of this, the power transmitted by the planet wheel is always divided half to the operative connection sun wheel/planet wheel and half to the operative connection planet wheel/ring gear. Therefore there is only one specific point for power to be input or taken off in the region of the planet wheel. Moreover the path which is transmitted to the ring gear as the planet carrier rotates about the central axis of the planet wheel is always twice as big as the path which the bearing or power transmission axle of the planet wheel here describes about the central axis of the planetary gear system. Therefore when power is input or taken off at the bearing axle, the power is halved with the path that is covered being doubled or vice versa. In other words, a force exerted on the power transmission axle is only half transmitted to the ring gear, which here covers twice the path covered by the power transmission axle. Finally there are limitations in respect of the arrangement of the three mentioned shafts. For example the web is always a combination of driving device or power take-off device and guiding element for the planet wheel.

These described facts cannot be varied in the construction of planetary gear systems and comparable gear systems which have linear or arcuate tracks. This results in numerous inconveniences for practical application, especially with respect to the transmissible torque and the possible transmission ratios.

In contrast to this, the technical problem underlying the present invention consists in so designing the gearbox device of the type mentioned initially that it can be realised more flexibly dimensioned than previously, with the power transmission improved and nevertheless with a circular or linear track for the power transmission axle, according to requirements.

The characterising features of claim 1 serve to solve this problem.

The invention brings with it the advantage that the power transmission axle, despite its eccentric and particularly advantageously adjustable arrangement on the bearing axle, can always be guided on a track which is parallel to the other tracks and in particular to the track on which the planet carrier is also moved. Moreover advantageous power transmission ratios are produced by this since the power transmission axle can be arranged much nearer than previously to one of the moved tracks, according to requirements. The new gearbox device thus makes possible many structures which could not be realised previously as well as the use of smaller or larger planet wheels and ring gears with otherwise the same ratios.

The use of different power input points (torque) at the bearing axle of the planet wheel into one and the same three-shaft planetary gear system is not provided in the previously known three-shaft epicyclic gears. By displacing the power input point (torque) at the bearing axle of the planet wheel out of the axial centre (eccentric power axle at the bearing axle) there exists the possibility of displacing the input of power (torque) at the planet wheel either in the direction of the operative connection sun wheel/planet wheel or in the direction of the operative connection planet wheel/ring gear, with simultaneous guidance of the bearing axle in the axial centre of the planet wheel by a carrier element.

In the case of a planetary gear system designed according to the invention and having three shafts, the latter advantageously, always lie outside the gear system. Therefore for example the drive of each shaft can take place from the inside of the gear system by means of a separate gearwheel, which is driven by the carrier element.

The invention also brings the advantage with it that the eccentrically arranged power axle at the bearing axle of the planet wheel describes a track running parallel to the track of the bearing axle. Due to the eccentrically arranged power axle at the bearing axle, many constructions are produced which could not be realised before, as well as the use of smaller ring gears and planet wheels with the same torque and the same sun-wheel diameter. A further advantage is that each drive shaft can be driven internally by the gear system itself, as is explained further on. Thus no external drive mechanism is necessary any longer and even a three-shaft epicyclic gear can be used as a crank mechanism, because the third shaft which interferes with the crank motion disappears. A further advantage lies in the fact that the internal drive of this shaft can be coupled with an external drive for this drive shaft, such that the two drive shafts support (supplement) one another in their driving work. Thus a four-shaft epicyclic gear is produced which has improved properties for power transmission. Finally it is advantageous that the driving does not have to come about; solely through an eccentric power axle at the bearing axle, but can also take place by power input directly at the carrier element. This arrangement has the same radius, when viewed from the axial centre of the sun wheel, as a power axle arranged eccentrically thereto, at the bearing axle.

Further advantageous features of the invention arise from the subordinate claims.

The invention is explained in greater detail below in conjunction with the attached drawings of embodiments. These show:

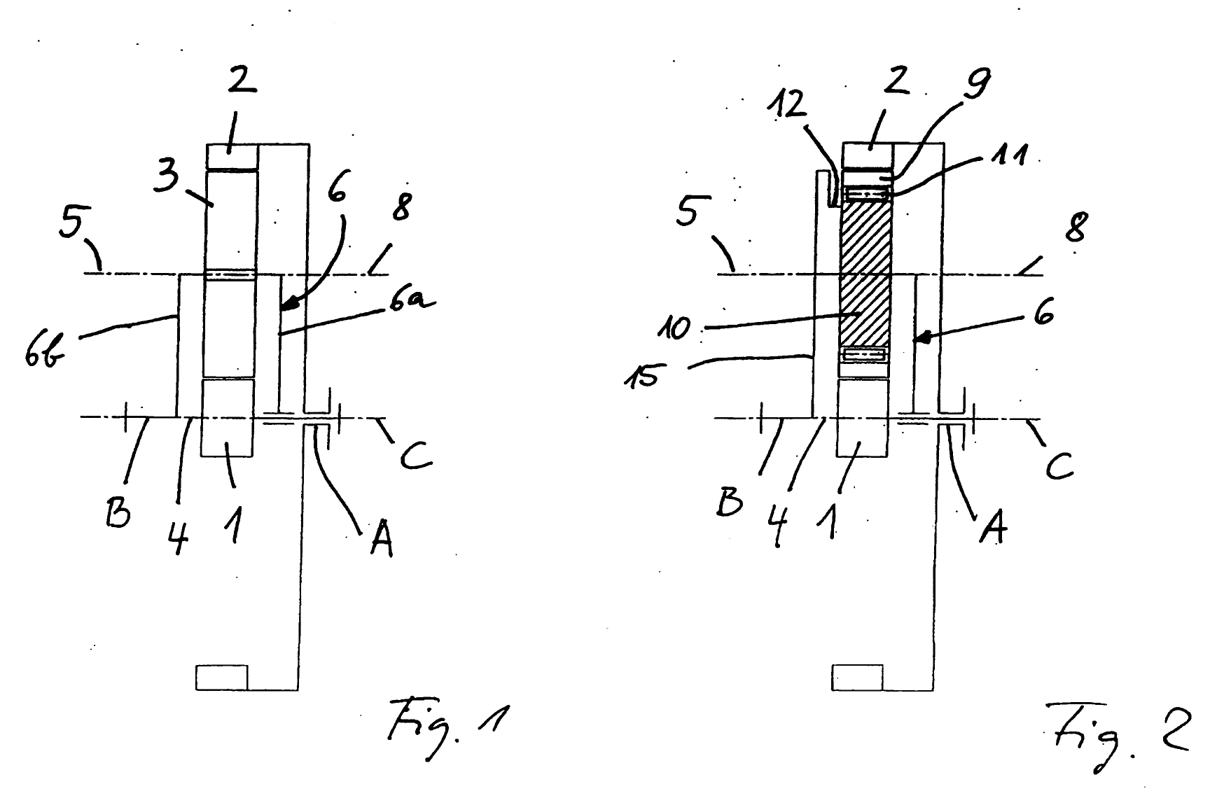

FIG. 1 a schematic illustration of a conventional planetary gear system having three shafts;

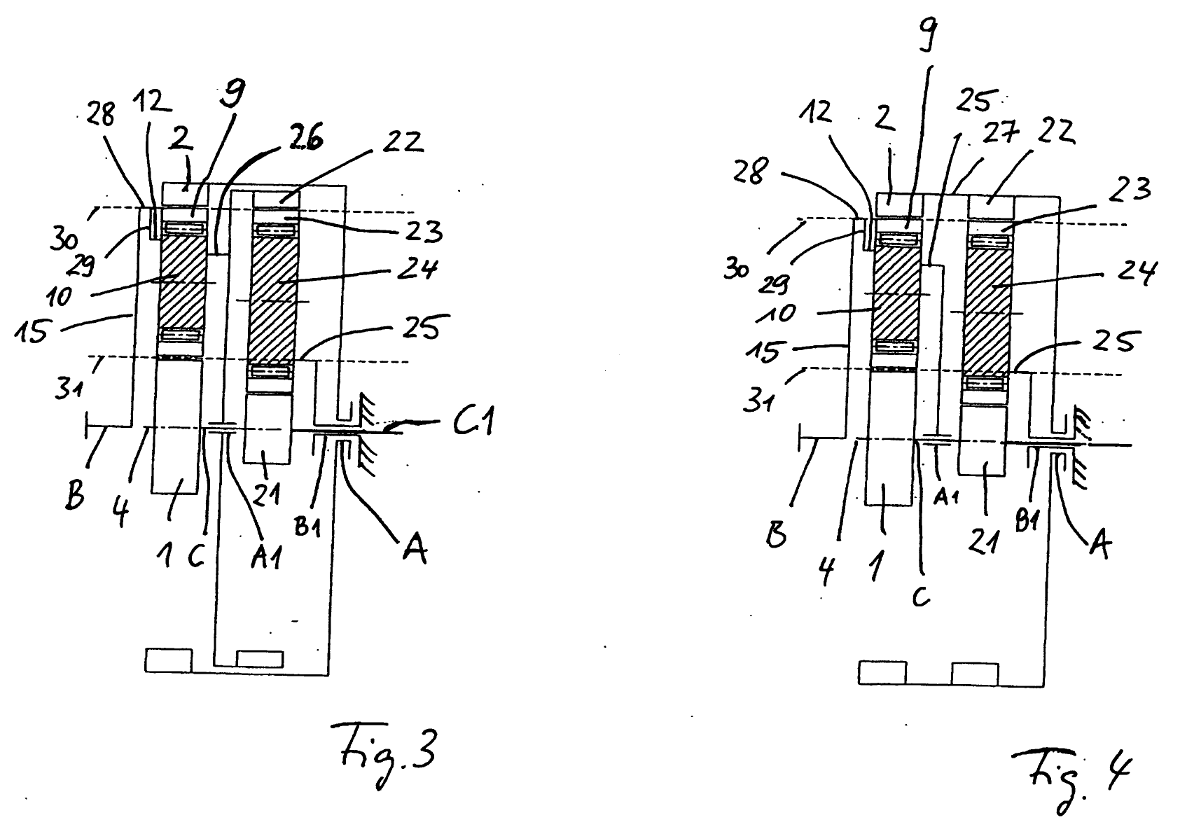

FIG. 2 a schematic representation of a gearbox device according to the invention in the form of a planetary gear system having three shafts and an eccentric power transmission axle;

FIG. 3 a schematic illustration of a planetary gear system composed according to the invention and having an internal and an external drive possibility for the outer sun wheel;

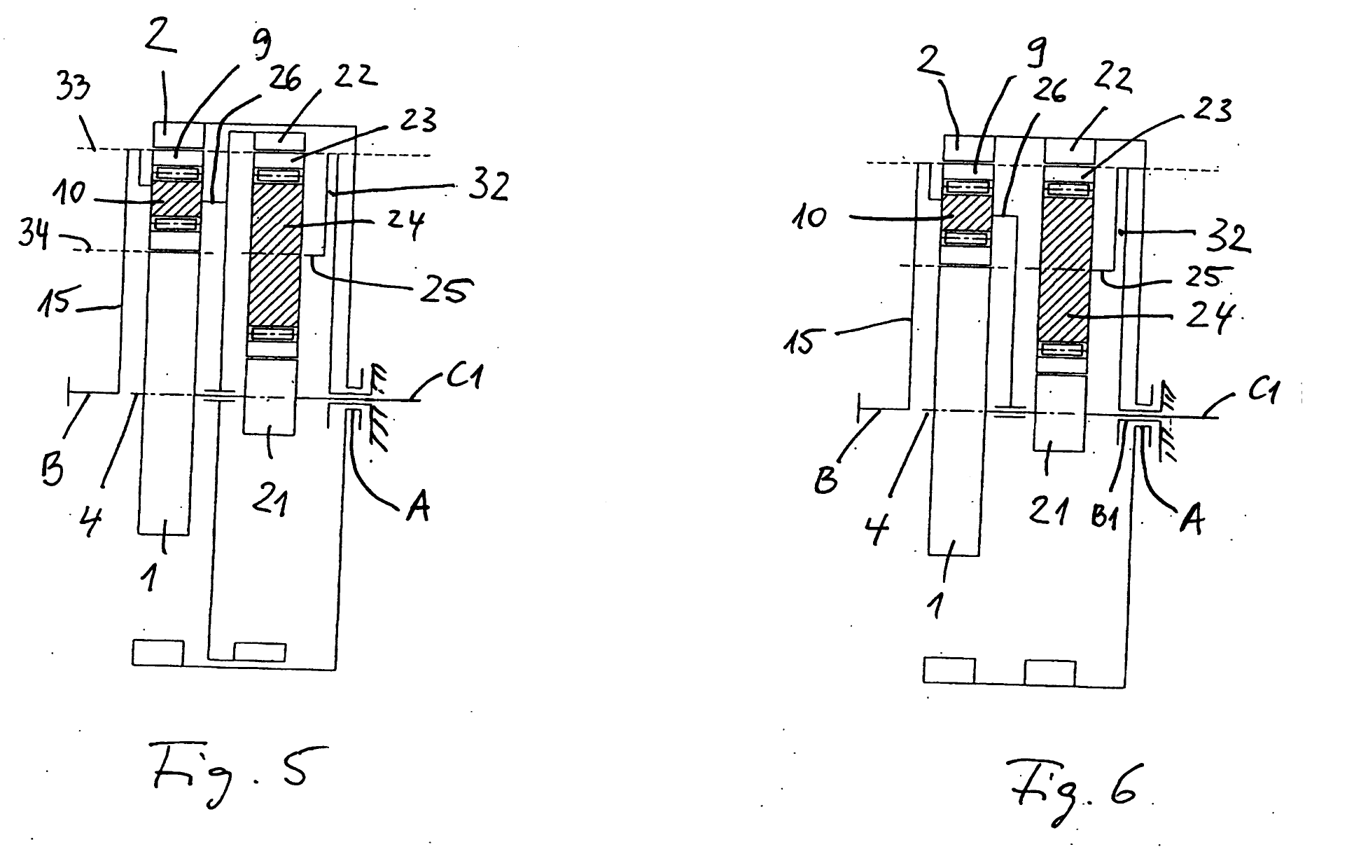

FIG. 4 a schematic representation of a planetary gear system composed according to the invention, in which the inner planet wheel is driven via a second ring gear arranged in parallel;

FIG. 5 a schematic illustration of a planetary gear system composed according to the invention, as per FIG. 3 but with altered dimensions;

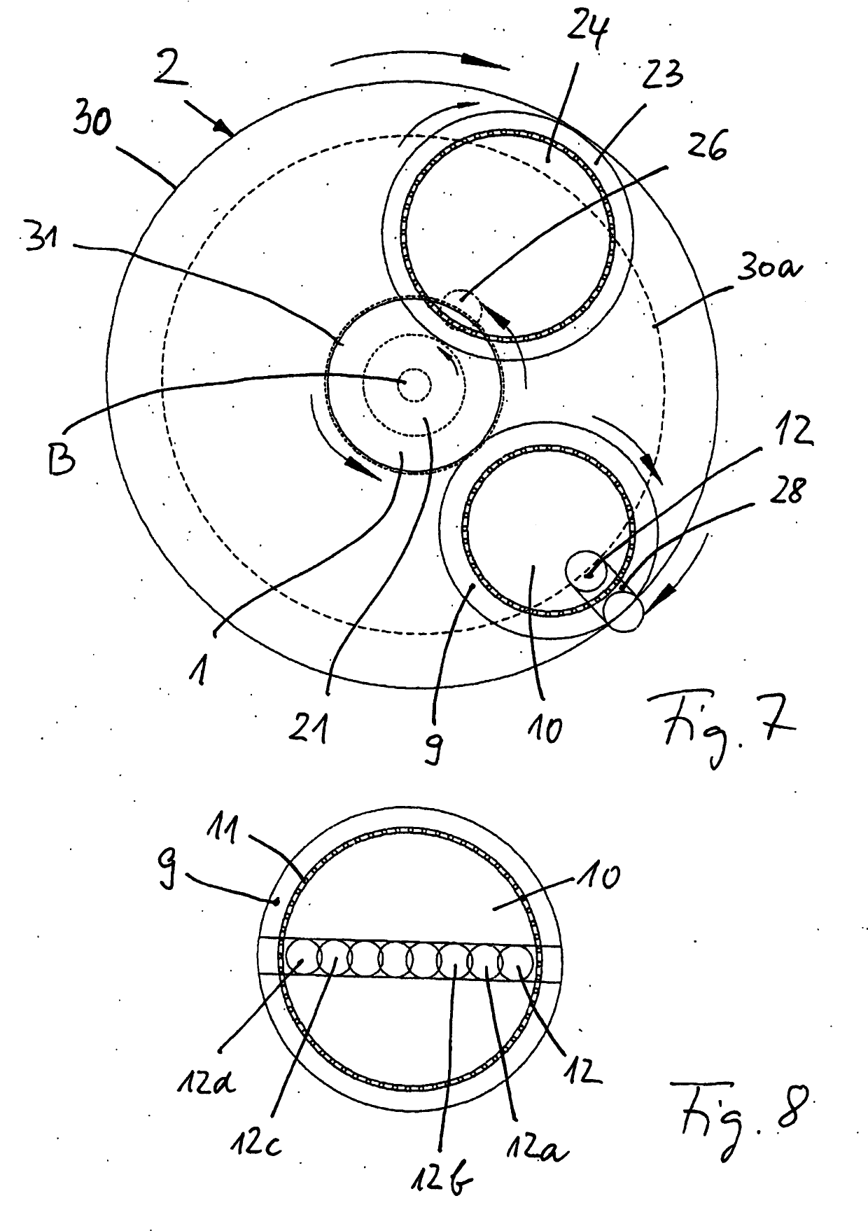

FIG. 6 a schematic representation like FIG. 4, but with altered dimensions similarly to FIG. 5;

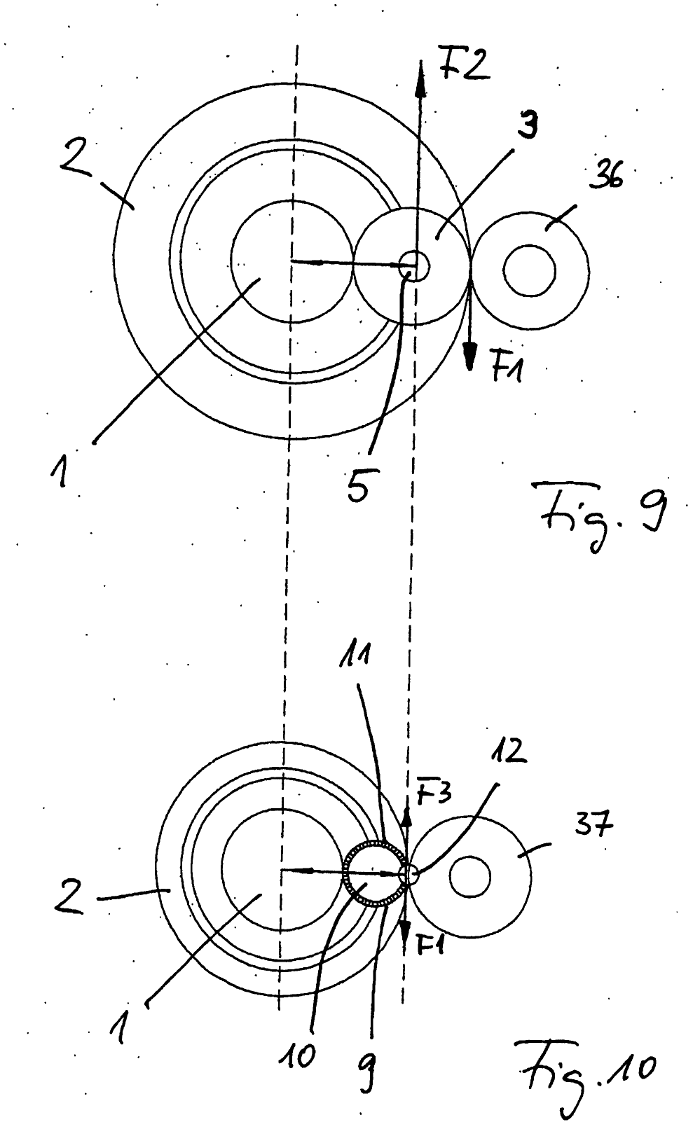

FIG. 7 a schematic cross-section through the planetary gear system according to FIG. 3;

FIG. 8 an illustration of a bearing axle with a planet wheel and the eccentric variability of their power axle here;

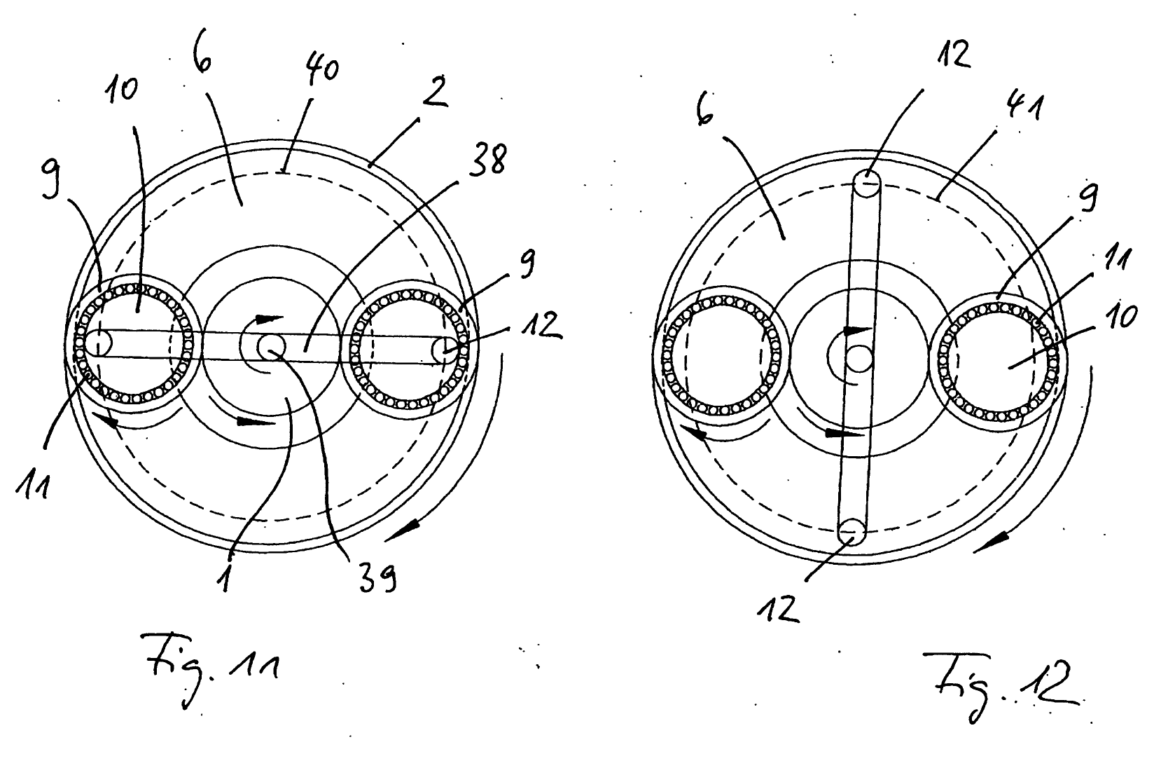

FIGS. 9 and 10 a schematic comparison of a known planetary gear system and one according to the invention;

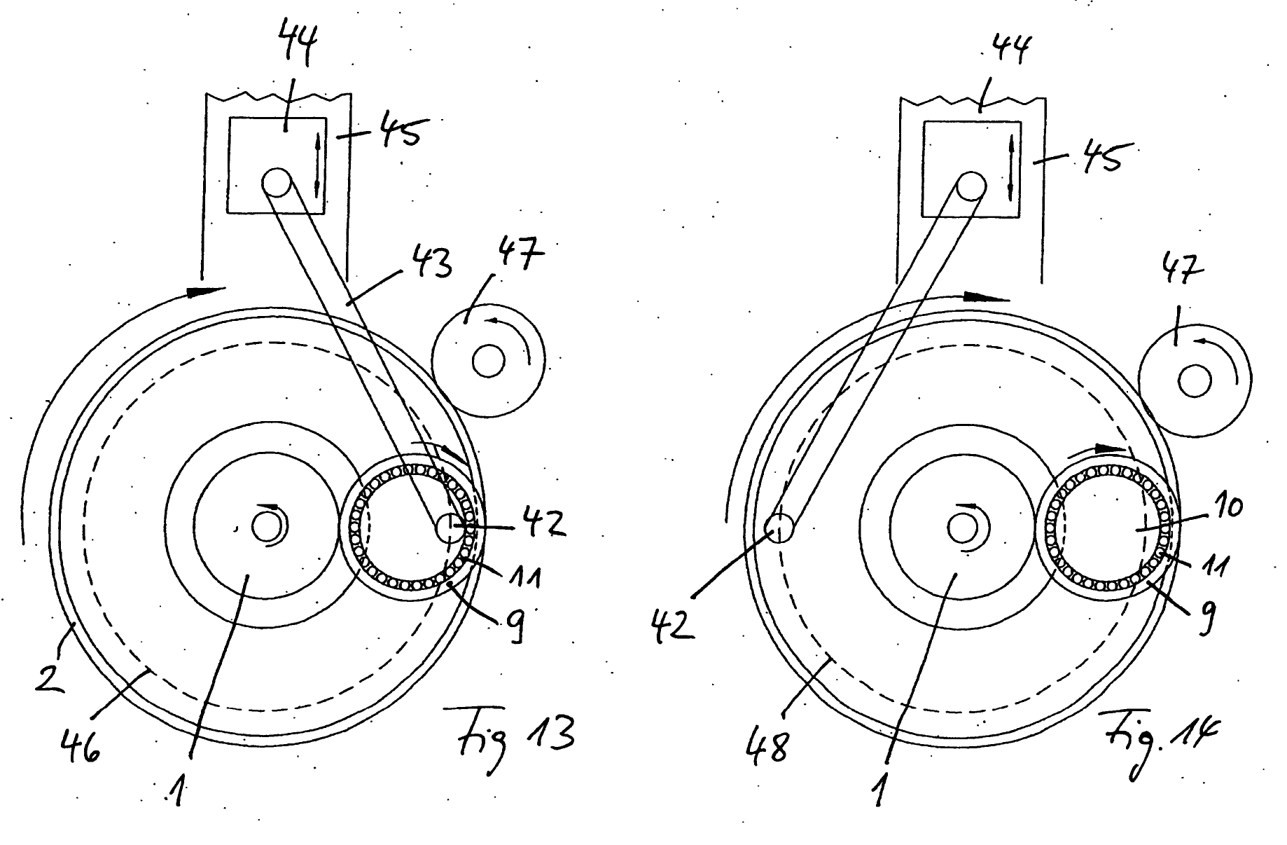

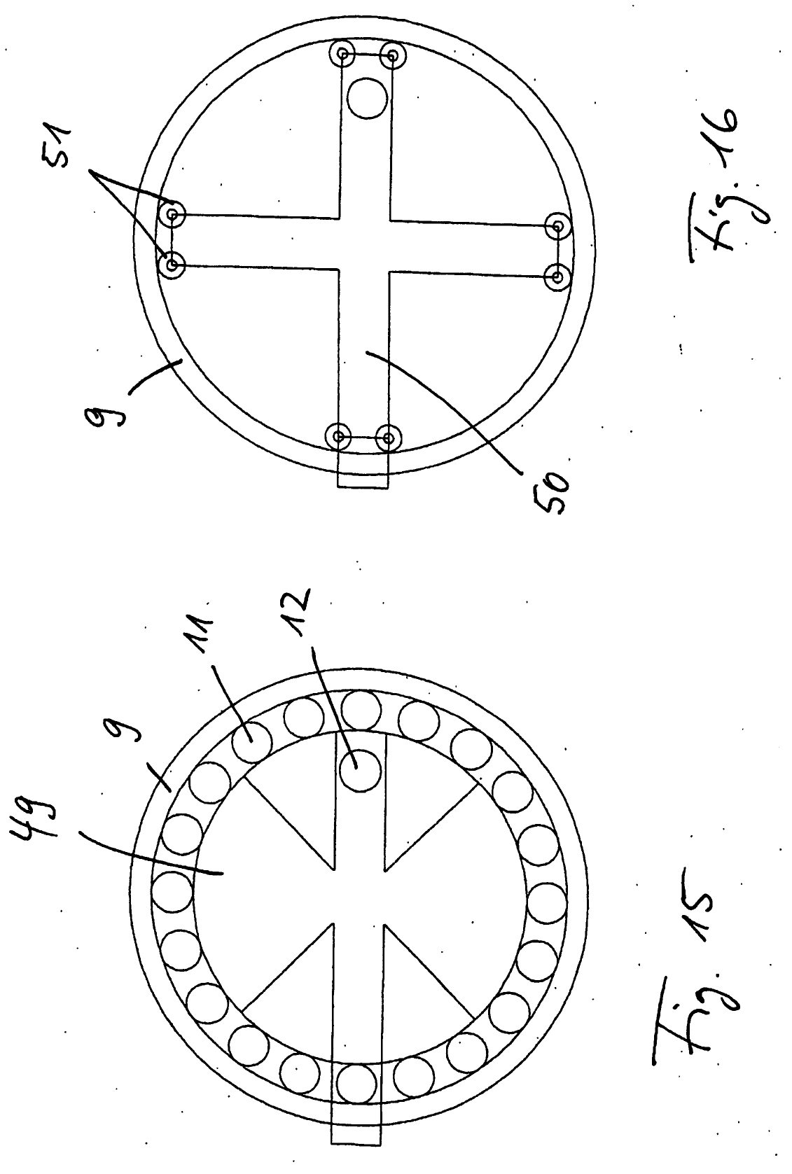

FIGS. 11 and 12 each a schematic front elevation of drive possibilities for the planetary gear system according to the invention;

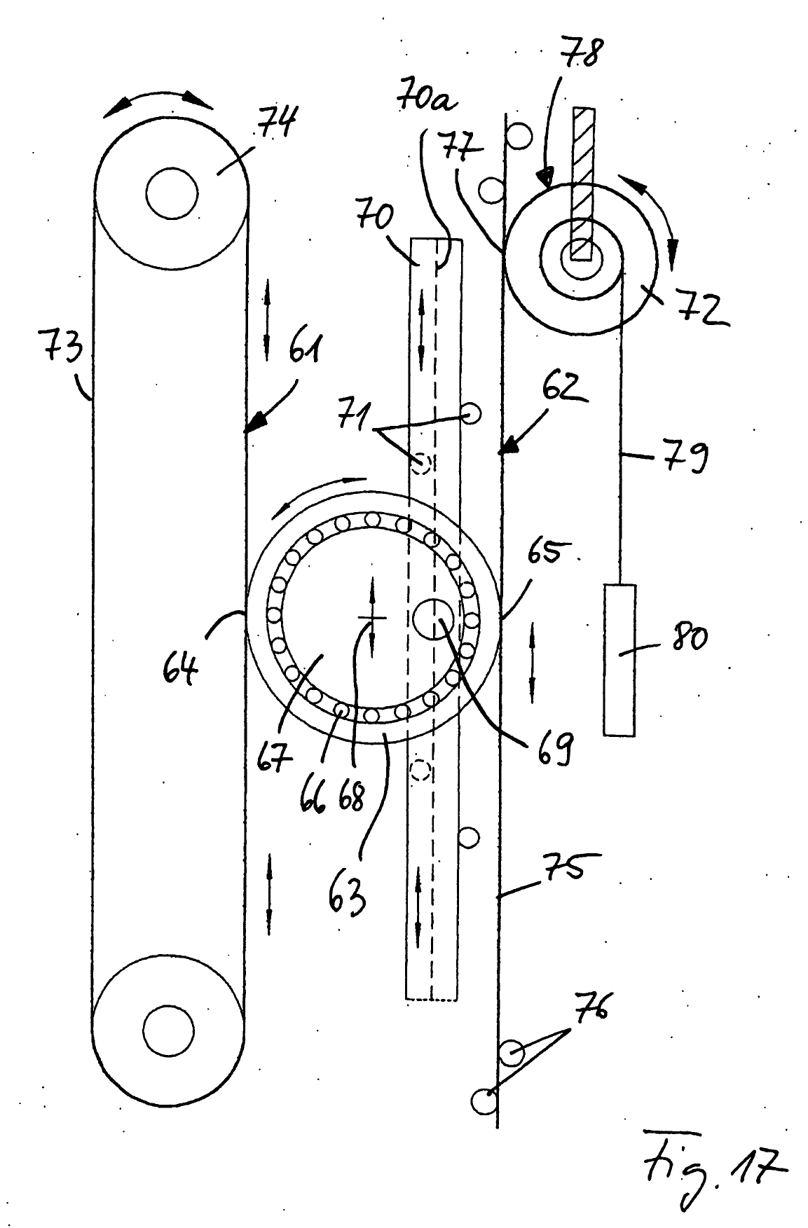

FIGS. 13 and 14 schematic front elevations each of a form of application of the planetary gear system according to the invention as a crank mechanism;

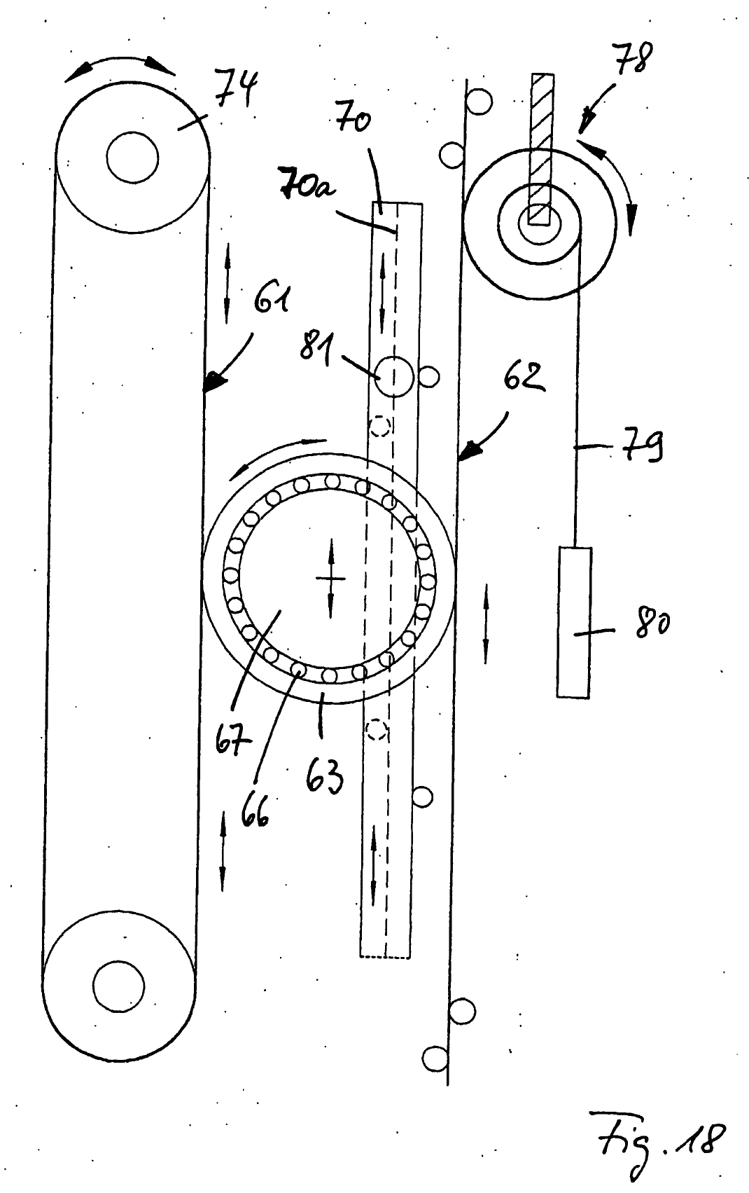

FIGS. 15 and 16 forms of embodiment of the bearing axle and of the bedding of the planet wheel;

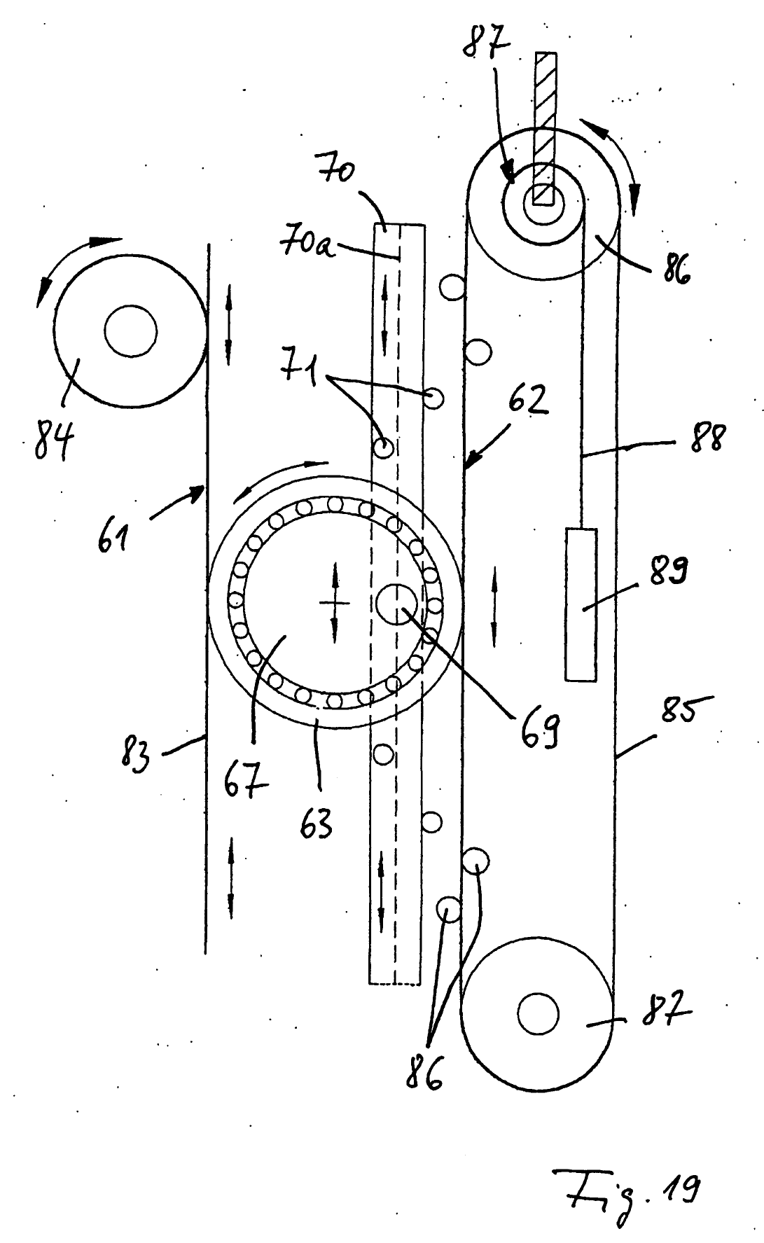

FIG. 17 a schematic illustration of a gear system according to the invention which is used in a lift where a second moved track is realised by a circulating chain or toothed belt;

FIG. 18 a schematic illustration of a gear system according to the invention as in FIG. 17, with a particular feature that the drive for the gearwheel takes place at the carrier element of the gearwheel;

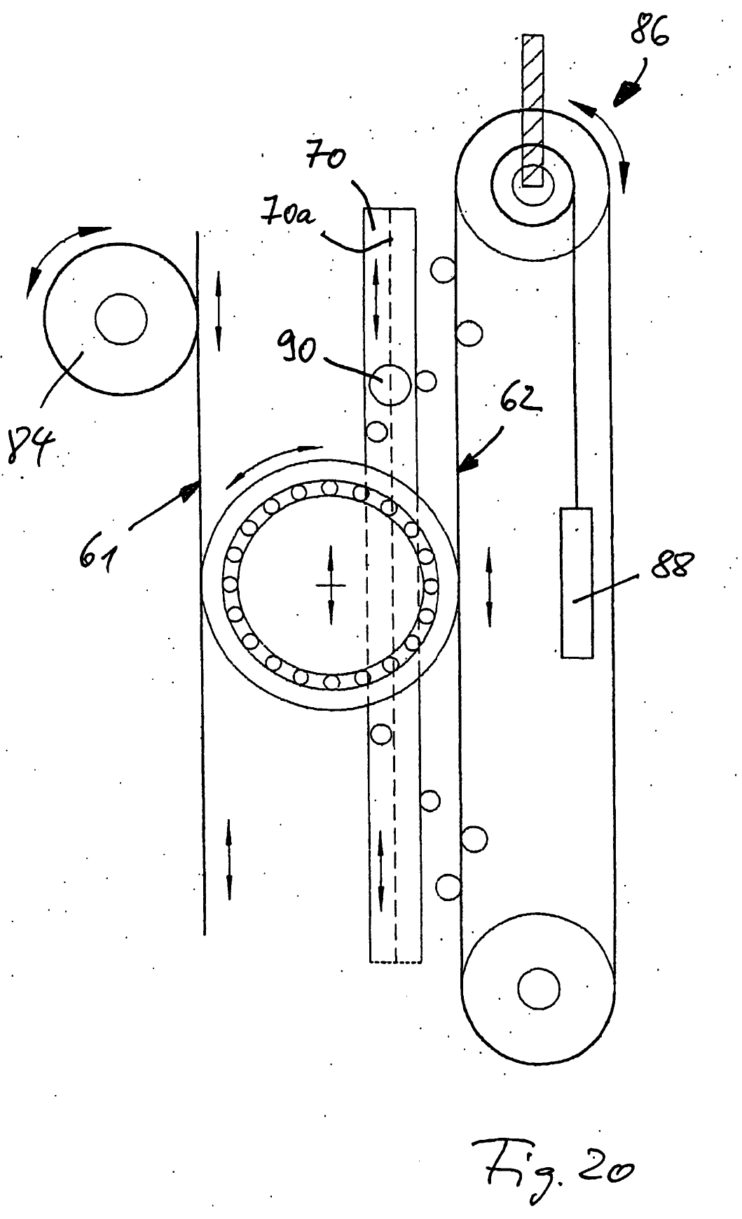

FIG. 19 a schematic illustration of a gear system according to the invention in which the second moveable track is realised by a rack being motor-driven by a gearwheel; and

FIG. 20 a schematic illustration of a gear system according to the invention as in FIG. 19, with the special feature that the drive for the gearwheel takes place at the carrier element of the gearwheel.

According to FIG. 1, a conventional gearbox device in the form of a three-shaft planetary gear system contains a sun wheel 1, a ring gear 2 and at least one planet wheel 3.

The ring gear 2 is provided with a first shaft A which is led towards the outside, is for example in the form of a hollow shaft and is mounted so as to be rotatable around a central axis 4 of the planetary gear system. The sun wheel 1 is for example provided with external teeth which form a first moveable, substantially circular track, whilst the ring gear 2 is provided for example with internal teeth which form a second substantially circular track which is also moveably mounted, which is arranged coaxial with and parallel to the first track and surrounds the latter at a pre-selected spacing. Between the two tracks, the planet wheel 3 is so arranged that it is operatively connected to the two tracks at substantially diametrically opposite points by being, for example, provided with external teeth which mesh with the teeth the two tracks of the sun wheel 1 or ring gear 2.

The planetary gear system has furthermore, per planet wheel 3, a bearing axle 5 which is only schematically illustrated and which is secured to a planet carrier or web 6 and arranged at a spacing from and parallel to the central axis 4. The bearing axle 5 or the bearings connected with it serve to rotatably mount the planet wheel 3. The planet carrier 6 supports the bearing axle 5 expediently on either side of the planet wheel 3 with arms 6a, 6b, which are mounted rotatable about the central axis 4, at least one arm (e.g. 6b) being able to be made to rotate by a second shaft B. The consequence of this is that the planet wheel 3 rolls along the outer track of the sun wheel 1 and takes the ring gear 2 along on its inner track and causes it to rotate about the central axis 4. The sun wheel 1 is moreover connected to a third shaft C, which for example is rotatably mounted in the first shaft A.

As a result of the described arrangement, the bearing axle 5, which generally has a small diameter, is simultaneously a power transmission axle which converts the circular motion of the carrier 6, or the force acting on the bearing axle 5 of the planet wheel 3, into a corresponding rotation of the ring gear 2. Moreover the central axis 8, coaxial with the bearing axle 5, of the planet wheel 3 is at the same time its axis of rotation, around which it executes a rotary movement in circling round the sun wheel 1.

A special feature of the described planetary gear system also consists in the fact that, when the shaft B is driven, the circulating motion of the ring gear 2 can be influenced in that simultaneously the sun wheel 1 is moved by means of shaft A in the one or other direction of rotation.

In respect of the movement possibilities, the following application forms arise as a function of which of the shafts A, B or C is driving or is driven:
Drive at B, power take-off via A and C;
Drive at A, power take-off via B and C;
Drive at C, power take-off via A and B;
Drive at A and B, power take-off via C;
Drive at B and C, power take-off via A;
Drive at A and C, power take-off via B.

Thus according to the individual case, shaft A takes over the power transmission from or to the ring gear 2 and shaft C the power transmission from or to the sun wheel, 1, whilst shaft B transmits the input power or the take-off power via web 6b to the axis 5 of the planet wheel 3.

Furthermore, the carrier element 6a, which can be in the form of a ring or of an arm, takes on the function of supporting and guiding the planet wheel 3 between the moved track of the sun wheel 1 and the moved track of the ring gear 2. This guidance takes place via a connection of the rotatably mounted carrier element 6a (arm) to axis 8. The planet wheel 3 is rotatably mounted on bearing axle 5. The carrier arm 6a and the web 6a both form a connection between the central axis 8 of the planet wheel 3 and a central axis 4 of the gear system. The two connections of the support arm 6a and the web 6b between the central axis 8 of the planet wheel 3 and the central axis 4 always produce the same (identical) spacings for both connections.

Or to put it another way, the central axis 8 of the planet wheel 3 and the central axis of the bearing axle 5 as well as the central axis of the power transmission axle are identical in their position and lie parallel to the central axis 4 of the sun wheel 1. The axial centre of the driving or driven shafts A, B and C is also identical in position to the central axis 4 of the sun wheel 1.

In this form of construction of three-shaft planetary gear systems, the point of power transmission, i.e. of power input or power take-off at the planet wheel 3 is always identical with the central axis 8 of the planet wheel 3. Thus for the individual three-shaft planetary gear system there is only one point at which power is input or taken off at the planet wheel 3.

A disadvantage of the described arrangement consists in the fact that the input power in the axial centre of the planet wheel (central axis 8) is always distributed half and half to the two operative connections planet wheel/ring gear and planet wheel/sun wheel. A further disadvantage is that the gearing structure always requires three shafts, i.e. one shaft for each part which is to drive or be driven (sun wheel, planet wheel and ring gear), which shafts are optionally driven or have power taken off as a driving or driven shaft from outside the gear system. Outside the gear system these shafts are connected to a drive motor or a component to be driven.

In the planetary gear system according to the invention which is represented in FIG. 2, the sun wheel 1 and the ring gear 2 are designed as in FIG. 1. The outer perimeter of at least one planet wheel 9 also corresponds to that of the planet wheel 3 in FIG. 1. The planetary gear system according to FIG. 2 differs however in two essential features from the planetary gear system according to FIG. 1. A first different feature consists in the fact that the planet carrier 6 has a bearing axle 10, shown hatched in FIG. 2, for each planet wheel 9, the outside diameter of this bearing axle being only slightly smaller than the outside diameter of the planet wheel 9 and preferably larger than corresponds to half the outside diameter of planet wheel 9. Here planet wheel 9 is in the form of a ring and rotatably mounted on the bearing axle 10, e.g. by means of a bearing 11 which can be in the form of a ball bearing, needle bearing or roller bearing or the like. A second different feature consists in the fact that, for power input or take-off, a power transmission axle 12 arranged parallel to the central axis 4 of the gear system is used, this power transmission axle being arranged eccentrically with respect to the central axis 8 of the planet wheel 9 and at the bearing axle 10. This central axis 8 here corresponds to the central axis 8 in FIG. 1 and is simultaneously the axis of rotation around which the planet wheel 9 can rotate on the bearing axle 10.

According to FIG. 2, the power transmission axle 12 is connected, e.g. via a lever arm 15 or the like, to the drive shaft B. In the gearbox device according to the invention, the carrier 6 which is rotatable about the central axis 4 of the planetary gear system thus serves merely to receive or mount the bearing axle 10, whereas the power transmission axle 12 serves via the lever arm 15 as a driving or driven member, via which power is input or taken off. What is important here is that the power transmission axle 12 is parallel to the central axis 4 and on moving describes a track which is concentric with the other tracks and has a constant radius or spacing from the central axis 4.

From FIG. 2 can be clearly recognised that in the static state, the eccentric arrangement of the power transmission axle 12 on bearing axle 10 and the power input there can lead to overload on each of the two operative connections at the planet wheel 9, either on the operative connection sun wheel/planet wheel or on the operative connection planet wheel/ring gear insofar as the ring gear 2 is driven via shaft B for example. In FIG. 2, this is the operative connection planet wheel 9/ring gear 2. This overload on one of the two operative connections is a function of the respective spacing of the eccentricity of the power transmission axle 12 from the central axis 8 of the planet wheel 9. Due to the eccentrically mounted power transmission axle 12 being moved towards one of the two operative connections (in FIG. 2 it is the operative connection planet wheel 9/ring wheel 2), there is inevitably relief of the other operative connection. The relieved operative connection (in FIG. 2 the operative connection planet wheel 9/sun wheel 1) should then be used to a greater extent as a drive for the power take-off of shaft C, which leads from outside to the gear system. Thus the drive which is preferably used to increase the speed where the power is low, takes place at the gear system in FIG. 2 at the relieved point of, the operative connection sun wheel/planet wheel and preferably in an opposite direction of rotation to the direct action of force at the eccentric power axle 12. The power transmission takes place on the other hand via shaft B, and the power off-take via ring gear 2 at shaft A. Thus the advantage is achieved that the power outlay required to drive shaft C is substantially smaller than in the uniform power distribution at the planet wheel according to FIG. 1.

FIG. 3 shows an assembled epicyclic gear which is also described as a planetary coupled gear. It comprises two planetary gear systems according to FIG. 2, which are arranged coaxially the one behind the other, the first planetary gear system being similar to the one according to FIG. 2, whilst the second planetary gear system has a sun wheel 21, a ring gear 22, at least one planet wheel 23 and a bearing axle 24 for same. A power transmission axle 25 of the second planetary gear system is arranged eccentrically at the bearing axle 24 as in FIG. 2 but, in contrast to FIG. 2, in the vicinity of the operative connection planet wheel 23/sun wheel 21.

Thus the side of the relieved operative connection of the first planet wheel 3 lies on the side of the relieved operative connection of planet wheel 23 and vice versa. This type of arrangement of the eccentric power axles in respect of one another brings the advantage that the respectively relieved side of the planet wheel (when viewed from the axial centre of the planet wheel) is driven in each case by the more strongly loaded side of the other planet wheel.

The coupling of the two planetary gear systems comes about in that the bearing axle 10 of the first gear system is connected via a coupling element 26 to the ring gear 22 of the second gear system. Coupling element 26 is rotatably mounted with a hollow shaft A1 on shaft C, which here interconnects the two sun wheels 1, 21 securely and coaxially. Shaft C is moreover guided through sun wheel 21 and ends as shaft C1 which is freely accessible from outside.

The shaft A provided at the ring gear 2 is guided in FIG. 3 over the second planetary gear system and is again partially configured as a hollow shaft which here rotatably receives shaft C1. Moreover, there is provided coaxially between the shafts C1 and A a hollow shaft B1 which is connected via power transmission axle 25 to the bearing axle 24 and is also guided outwards out of the gear system. There the shaft B1 is mounted stationary by being securely connected to a gearbox housing, as is indicated schematically in FIG. 3.

The operation of the gearbox device according to FIG. 3 is substantially as follows:

If for example shaft B is driven, the planet wheel 3 is taken with it via power transmission axle 12 and the ring gear 2 is taken by the planet wheel 3. Via the coupling element 26, the ring gear 2 drives the second ring gear 22 in the same direction of rotation. In this process, the ring gear 22 attempts to take the second bearing axle 24 with it. However since this is held stationary by the power transmission axle 25, the second planet wheel 23 transmits the movement of the ring gear 22 to the second sun wheel 21 and rotates the latter in the opposite direction of rotation. Since sun wheel 21 is securely connected to the first sun wheel 1, the latter is therefore also driven in a direction of rotation which is the opposite direction from that of the drive shaft B. A consequence of this is an increase or reduction in speed of the ring gear 22 and thus of the driven shaft A in the same way as if shaft C were driven from outside by means of a second drive mechanism. This second drive mechanism is not necessary according to the invention and the speed of the sun wheel 1 can be in principle selected to be any speed at all with the aid of the numbers of teeth of the second gear system 21 to 26.

The type of drive in FIG. 3 could be described as an internal sun wheel drive since an external drive for the sun wheel 1 is no longer required. The shaft C1 which is guided outwards is therefore superfluous in this application and is used at the most for mounting the sun wheel 21.

Further variants of the gearbox device according to FIG. 3 arise through an optionally fixed or rotatable arrangement of the bearing axle 24 and the central or eccentric coupling of the coupling element 26 to the bearing axle 10. Uniform loading at the first planet wheel 9 is produced if the power transmission axles 12 and 25 are coaxial.

The embodiment according to FIG. 4 corresponds to that according to FIG. 3 apart from the difference that the second ring gear 22 is driven directly by the first ring gear 2 by means of a coupling element 27. Since shaft B1 is again held securely, the ring gear 22 transmits its movement via the rotating planet wheel 23 to the sun wheel 21 in an opposite direction of rotation. The connection between the bearing axle 10 and the ring gear 22 disappears here.

Further variants of FIGS. 3 and 4 are possible through different arrangements of the individual operative connections and their bearings in relation to one another. Preferably in FIGS. 3 and 4 the position or arrangement of the meshing should be so selected that the two meshings of the planet wheels 9 or 23 with the ring gear 2 or 22 are identical with the central axis of journals 28 arranged eccentrically on a lever arm 29 (shown in FIG. 3 by the broken line 30). Furthermore the position (arrangement) of the central axis of the eccentrically arranged power axle 25 at the bearing axle 24 should be identical with the position of the operative connection sun wheel 1/planet wheel 9 (shown in FIG. 3 by a broken line 31). Both types of arrangement are shown in FIGS. 3 and 4 by broken lines 30 and 31.

In its basic structure, FIG. 5 corresponds to FIG. 3. What are altered in FIG. 5 are the outside diameter of sun wheel 1 and planet wheel 9 as well as the outside diameter of the bearing axle 10 of the planet wheel 9. Moreover the eccentric position of the power transmission axle 25 at the bearing axle 24 is altered to a central position at bearing axle 24. The central power transmission axle 25 moreover has a U-shaped arm 32, which extends as far as the operative connection planet wheel 9/ring gear 2 or planet wheel 23/ring gear 22 (shown in FIG. 5 by a broken line 33). A further special feature consists in the fact that the central axis of the power transmission axle 25 at bearing axle 24 has the same spacing (radius) from the central axis 4 as the operative connection between the first planet wheel 9 and the first sun wheel 1 (broken line 34 in FIG. 5). In FIG. 5, too, internal driving of the first sun wheel 1 is possible as in FIG. 3.

The bearing axle 24 of the second planet wheel 23 can moreover be optionally arranged rotatable or kept fixed according to the desired transmission, which is also true for FIGS. 3 and 4.

FIG. 6 corresponds to FIG. 4 apart from the differences that the first planet wheel 9 has a smaller diameter and the second power transmission axle 24 has the U-shaped arm 32 according to FIG. 5.

FIG. 7 shows schematically the assembled gear system according to FIGS. 3 and 4 from the front end side, i.e. in FIG. 3 from the left. The eccentrically arranged power axles 12 and 25 at the two bearing axles 10 to 24 are arranged offset (opposite), as described in FIGS. 3 and 4. The diagram in FIG. 7 shows the direction of rotation of the first and second sun wheels 1, 21 as well as the direction of rotation of the ring gears 2, 22 and the direction of rotation of the first and second planet wheels 9 or 23. The direction of the opposite action of force of the two is clear from the two arrowheads at the two power axles 12, 25.

The direction of the action of force at the eccentrically arranged power transmission axles 12, 25 is determined by the position of the arrangement of the eccentric power axle at the bearing axle of the planet wheel. The position of the eccentricity at the bearing axle decides the direction of the action of force at the power axle.

If the power axle 12 moves in the direction of ring gear 2, the direction of the action of force at the power axle 12 is the same as the direction of rotation of ring gear 2. If the power axle 25 moves in the direction of sun wheel 21, the direction of the action of force at the power axle 25 is the same as the direction of rotation of the sun wheel 21. The two tracks of the power axles 12 and 25 can be recognised by the broken line 30a, these tracks extending respectively through the central axis of the two power axles 12 and 25 and lying parallel to one another. Moreover the circular lines 30 and 31 in FIG. 7 show a first moveable track, defined by the inner casing of the ring gear 2, and a second, also moveable, track, defined by the outer casing of the sun wheel 1. Between these two tracks 30, 31, the central axis of the power transmission axle 12 circulates on a track which is parallel to tracks 30, 31 and is at a fixedly prescribed spacing from same.

At the first power axle 12, the action of force on the radius of the operative connection planet wheel/sun wheel is realised by an extended arm 29 with a journal 28 placed on it. The central axis of the second power axle 25 at the second bearing axle 24 of the planet wheel 23 is exactly on the radius of the operative connection of the first sun wheel 1/first planet wheel 9 (indicated by the broken line 31, as described in FIGS. 3 and 4.)

FIG. 8 shows a planet wheel 9 with an enlarged bearing axle 10 and the different possible variations of the eccentrically arranged power transmission axle 12 at the bearing axle 10. The power transmission axle 12 can also be arranged so as to be displaceable at the bearing axle 10.

The power transmission axle 12 can be realised technically for example by the central axis of a journal projecting vertically from the bearing axle 10. According to a particularly preferred embodiment of the invention, this journal, as indicated in FIG. 8, is mounted on the bearing axle 10 so as to be displaceable along a diameter, such that the power transmission axle 12 can be arranged, according to requirements, more or less distant from the axis of rotation 8 (FIG. 2) of the planet wheel 9 and can be brought into a large number of possible positions (e.g. 12a, 12b, 12c or 12d). To this end, for example a journal realising the power transmission axle 12 may be displaced in a diametrically extending groove of the bearing axle 10 and may be arranged fixable by means of a clamping screw or the like. During the operation of the planetary gear system, the power transmission axle 12 is naturally in each case set at a prescribed fixed spacing from the axis of rotation 8.

FIG. 9 shows a conventional three-shaft planetary gear system (as described in FIG. 1), having a power take-off element 36 rolling on the outer circumference of the ring gear 2. As already mentioned in FIG. 1, there is a distribution of the power input in the axial centre of the planet wheel 3, half of it going to the operative connection planet wheel/sun wheel and half to the operative connection planet wheel/ring gear. This results in the following power distribution at the planet wheel. Force F2 is, with a static equilibrium at the planet wheel 3, twice as large as the opposite force F1 at the outer operative connection planet wheel 3/ring gear 2 or ring gear 2/power take-off element 36. Since in the gearbox device according to the invention both the sun wheel 1 and the ring gear 2 are mounted so as to be moveable or rotatable, for the assumed static equilibrium a correspondingly large force would have to be brought to bear on the sun wheel or ring gear (counterforce). The same behaviour of the forces applies also to the operative connection planet wheel 3/sun wheel 1. Thus the gear system shown in FIG. 9, like all the other gear systems of this design, has only a single point for the input of power at the bearing axle 5 in the axial centre of the planet wheel 3. This point is identical to the central axis of the bearing axle 5. What is also important in this connection is that the size of the sun wheel 1 and of the ring gear 2 is fixed by the diameter of the planet wheel 3 and thus invariable due to the fixing of the power input in the axial centre of the planet wheel 3. The outer circumference of the sun wheel 1 in this example is 94.2 mm.

The inner casing of the ring gear 2 is 282.6 mm. The outside diameter of the planet wheel 3 is 94.2 mm. The outside diameter of the power take-off element 36 is 94.2 mm. The length of the track of the central axis of power axle and bearing axle 5 during a revolution around the sun wheel 1 is 188.4 mm. During a revolution of the planet wheel 3 around the sun wheel 1 and simultaneously a revolution of the sun wheel 1 in the opposite direction of rotation of the ring gear 2, there is a transmission ratio of 1:5 on the power take-off element 36.

FIG. 10 shows a three-shaft planetary gear system according to the invention, as described in FIG. 2 but with one alteration: the ring gear 2 drives at its outer perimeter a power take-off element 37. The eccentric power axle 12 at the bearing axle 10 was moved to the radius of the operative connection planet wheel/ring gear/power take-off element. The outer circumference of the sun wheel 1 is 94.2 mm. The inner casing of the ring gear 2 is 188.4 mm. The outside diameter of the planet wheel 9 is 47.1 mm. The outside diameter of the power take-off element 37 is 94.2 mm. The length of the track of the central axis of the power, axle 12 during a revolution around the sun wheel 1 is 188.4 mm. During a revolution of the planet wheel 9 around the sun wheel 1 and simultaneously a revolution of the sun wheel 1 in the opposite direction of rotation from the ring gear 2, there is a transmission ratio of 1:4 to the power take-off element 37. The spacing of the central axis of the power transmission axle 12 from the axial centre of the sun wheel 1 in FIG. 10 is identical with the spacing between the central axis of the power transmission axle and bearing axle 5 of FIG. 9.

The static equilibrium at the planet wheel 9 was altered in favour of the operative connection planet wheel 9/ring gear 2, such that for force F1 an opposite force F3 is required at the operative connection planet wheel 9/ring gear 2 or respectively ring gear 2/power take-off element 37, which corresponds to the size of F1.

FIG. 11 shows a three-shaft planetary gear system according to the invention which has two planet wheels 9 lying opposite one another. The two eccentrically arranged power transmission axles 12 at the two bearing axles 10 are connected to one another with the aid of a connecting part 38 via the axial centre of the sun wheel 3. The connecting part 38 has in the axial centre of the sun wheel 1 a shaft 39 for driving or taking power from the two planet wheels 9. The shaft 39 is here axially parallel to the power axles 12 of the planet wheels 9.

The direction of rotation of drive shaft 39 is the opposite from the direction of rotation of the sun wheel 1. The broken line 40 shows the track of the central axes of the power transmission axles 12 which extends parallel to the ring gear 2 and sun wheel 1.

FIG. 12 shows a three-shaft planetary gear system according to the invention as in FIG. 11, with the special feature that the power transmission axles 12 are no longer arranged at the bearing axles 10. The power transmission axles 12 are located directly on the carrier element 6 for the planet wheels 9 according to FIG. 2 (ring, arm or other forms), but nevertheless on the same radius (broken line 41), as described in FIG. 11. They are arranged axially parallel to the central axis of the sun wheel 1. The power transmission axles 12 are mounted on the carrier element 6 on the same radius of the respective eccentricity as in FIG. 11. A corresponding arrangement of the power transmission axle 12 at the planet carrier 6 can be provided in FIG. 2.

FIG. 13 shows a three-shaft planetary gear system according to the invention, which is used as a crank mechanism for a combustion engine. The eccentrically arranged power transmission axle 12 at the bearing axle 10 is in the form of a crank journal 42 and connected to a connecting rod 43. This connecting rod 43 has at its other end a connection to a piston 44, which moves backwards and forwards in a sleeve 45. The power axle 42 at the bearing axle 10 moves with its central axis on the broken line or track 46 and extends parallel to the track of sun wheel 1 and ring gear 2. The planet wheel 9 is driven by a drive element 47 at ring gear 2, and the piston works then as a pump or compressor. What is crucial is that for the effectiveness of this crank mechanism, the main drive force (high speed, low power) starts at the respectively relieved operative connection (in FIG. 13 the operative connection planet wheel 9/sun wheel 1).

FIG. 14 shows a three-shaft planetary gear system according to the invention with one alteration from FIG. 13. The crank journal 42 is not arranged at the bearing axle 10 of the planet wheel 9 but directly on the carrier element 6 and preferably offset by 180° in comparison with FIG. 13.

The crank journal 42 is located with its axial centre on the same radius as in FIG. 13 and its track (broken line 48) extends as in the other embodiments at a constant spacing from and parallel to the track of sun wheel 1 and ring gear 2.

FIG. 15 shows a bearing axle 49, which has a cut-out form and a bearing 11 arranged on it with planet wheel 9.

FIG. 16 shows a bearing axle 50 in a combination of cross and rod shapes, on which the planet wheel 9 is rotatably arranged by means of roller bearings 51.

The operating principle of the gearbox device according to the invention, described with the aid of FIGS. 2 to 16, can be transferred in an analogous manner also to gear systems which have linear tracks instead of circular tracks. This is described below by way of example with the aid of FIGS. 17 to 20. FIG. 17 shows a first linearly displaceable track 61 which can be understood as an unwinding of the outer perimeter of the sun wheel 1 according to FIG. 2. Parallel to this and at a spacing is a second track 62 which is also mounted so as to be moveable in a linear manner and which can be understood as an unwinding of the inner perimeter of the ring gear 2 according to FIG. 2.

Between the two tracks 61, 62 is arranged a planet wheel 63, the perimeter of which is in operative connection on the one hand at a point 64 with the moveable track 61 and on the other hand at a diametrically opposite point 65 with moveable track 62. Similarly to FIGS. 2 to 16, the planet wheel 63 is designed as a narrow ring which is rotatably mounted on a bearing axle 67 by means of a bearing 66, the outside diameter of said bearing axle being preferably only slightly smaller than corresponds to the outside diameter of the planet wheel 63. A central axis 68 of the bearing axle 67 is simultaneously the axis of rotation of the planet wheel 63. The bearing axle 67 can be secured to a carrier which is not shown in detail and which is mounted so as to be displaceable parallel to tracks 61, 62.

Analogously to FIGS. 2 to 16, the bearing axle 67 is also provided with a power transmission axle 69 arranged eccentrically with respect to the central or rotational axis 68 of the planet wheel 63, said power transmission axle being realised for example as a journal which protrudes vertically from the bearing axle 67 in the form of a circular disc. Finally, for driving or power take-off is used a guiding element 70 which is displaceable parallel to tracks 61, 62, is coupled to the power transmission axle 69 or the journal and which is mounted in appropriate bearings so as to be displaceable. The linear motion introduced with the guiding element 70 can be converted into a rotary motion by means of a wheel 72 which is operatively connected to the outside of the moveable track 62, and conversely the rotary motion of the wheel 72 can also be converted into a linear motion of the guiding element 70. With respect to the power transmission and the paths to be covered, the same principles apply as were explained above with the aid of FIGS. 1 to 16. In particular, the guiding element 70 is so designed and so guided by means of bearings 71 that on the one hand it can only be moved parallel to tracks 61, 62, and on the other hand power is transmitted from the guiding element 70 to the bearing axle 67 or conversely in the region of the power transmission axle 69 or the power direction parallel to tracks 61, 62 extends through the power transmission axle 69. Therefore, the guiding element 70 and the bearing axle could also be manufactured as one piece, even without a bearing journal being formed. So that no undesired lever actions are obtained between the guiding % element 70 and the bearing axle 67 or the bearing journal 69, its central axis expediently lies exactly on a line 70a, shown as a broken line, along which the guiding element 70 acts on the balls or the like of the bearings, or vice versa.

Track 61 is formed e.g. by a circulating chain 73 which forms the operative connection 64 with the planet wheel or gearwheel 63. On the other hand, the guiding element 70 comprises any guiding component which is held by the bearings 71, e.g. rollers, and is secured to the bearing axle 67 for example. With the aid of a gearwheel 74 around which track 61 winds at least partially, track 61 can be moved backwards and forwards in the direction of the arrows. Operative connection 64 here defines the relieved side.

The power transmission axle 69 also moves parallel between the two moveable tracks 61 and 62. Due to the action of force at the power axle 69, the gearwheel 63 moves with guiding part 70 between the two moveable tracks 61 and 62, whereby the gearwheel 63 is rotated and displaced between the two moveable tracks 61 and 62. The gearwheel 63 rolls over the second moveable track 61, the second moveable track 61 always being driven in the opposite direction from the displacement of the gearwheel 63. Thus in the case of a change of direction of the displacement of the gearwheel 63 with the aid of the guiding part 70, there must also be a change of direction at the second moveable track 61. The drive at gearwheel 63 via the first moveable track 62 is always in the same direction as the displacement of the gearwheel 63 onto the guiding element 70. The arrangement of the eccentric power axle 69 at the bearing axle 67 is always such that it sits as far as possible at the first moveable track 62 (power take-off track). Displacement of the eccentric power axle 69 onto the operative connection 65 between gearwheel 63 and the first moveable track 62 (power take-off track) is possible by means of a lever arm which is arranged at the bearing axle 67 or on the guiding element 70 and has a pin for introducing force. The arrangement of the eccentric power transmission axle 69 on the centre line 70a of FIG. 17 has proved to be advantageous because by this means additional disadvantageous lever actions between gearwheel 63 on bearing axle 67 and guiding part 70 are reduced. Or in other words, due to an offset arrangement between the eccentric power axle 69 and the guiding part 70 at the bearing axle 67, inevitably additional disadvantageous lever actions are produced at the bearing axle 67 between guiding part 70 and eccentric power axle 69. The first moveable track 62 is formed e.g. by a rack 75. This rack 75 is guided by the rollers 76. The gearwheel 63 is in operative connection 65 with the rack 75 and always moves it in the same direction as the displacement of the gearwheel 63 by guiding part 70. The eccentric power axle 69 is arranged at the bearing axle as far as possible at the operative connection 65. The rack 75 is e.g. in operative connection 77 with a winch 78 containing wheel 72 and drives the latter. On the winch 78 is arranged a cable 79 which can lift and lower a weight 80. The driving in FIG. 17 thus takes place firstly via the eccentric power axle 69 at the bearing axle and secondly via the second moveable track 61 which is formed by the circulating chain 73. The driving takes place via the first moveable track 62 which is formed by the rack 75.

FIG. 18 corresponds to FIG. 17 with one modification; a power transmission axle 81 is arranged at the guiding part 70 on the centre line 70a.

FIG. 19 corresponds in the structure of guiding part 70, bearing axle 67, needle bearing 66, planet wheel 63, transmission axis 69, centre line 70a and guide rollers 71 to the structure of FIG. 17. The second moveable track in FIG. 19 is realised by a rack 83 which is driven in alternate directions by a gearwheel 84. Here, too, the driving always takes place in the opposite direction to the displacement of the guiding part 70 with bearing axle 67 and gearwheel 63. The power take-off device at gearwheel 63 via the first moveable track 62 is a circulating chain 85 which is held and guided by guide rollers 86 and 87. The circulating chain 85 drives a gearwheel with a cable winch 87 on which a cable 88 is arranged which is used to lift and lower a weight 89. The driving in FIG. 19 thus takes place firstly via the eccentric power axle 69, at the bearing axle 67 and secondly through the second moveable track 61 which is formed by rack 83. Power take-off takes place via the first moveable track 62, which is formed by the circulating chain 85.

FIG. 20 corresponds to FIG. 19 with one modification: a power transmission axle 90 is arranged on the centre line 70a of the guiding element 70.

Other application possibilities arise from an arcuate or linear first and second track 61 and 62 with simultaneous arcuate or linear motion of the guiding part 70 which moves in a parallel manner between the two moved tracks 61 and 62.

Furthermore, application possibilities arise through the use of chains, belts, toothed belts, racks and cables as well as gearwheels for tracks 61 and 62. A further modified form of the gear system according to the invention consists in the second moved track 62 being formed by a gearwheel which can be either moveable or fixed. This gearwheel meshes in gearwheel 63 and rotates in the opposite direction from the displacement of gearwheel 62. In order to make this possible, the driving gearwheel runs in a guide rail beside gearwheel 63 and drives the latter. Furthermore it is also possible, however, for the driving gearwheel and gearwheel 63 to be fixed in place.

The invention is not restricted to the described embodiments which can be modified in many ways. This applies particularly to the dimensions and the arrangements of the various parts in relation to one another, all quoted by way of example. The planetary gear system can for example also be equipped with more than one or two planet wheels. Furthermore, the bearing axle can also be designed differently from what is indicated in FIGS. 7, 8, 15 and 16. It is in particular possible to design the bearing axle multi-part. Here it can be particularly expedient to provide it with two coaxial parts lying axially the one behind the other and interconnected by a spring element. Thus forces acting suddenly on one of the parts can be cushioned before they act on the other part. Moreover it can be advantageous to design the ring gear 2 at the outer perimeter as a driving or driven member by providing it with peripheral teeth or the like for example. Alternatively, the driving or driven member can also comprise a plurality of wheels, especially toothed wheels, of different diameters and arranged coaxially the one behind the other in order to make possible different transmission ratios in a simple manner. Instead of being a circular disc, as indicated in FIG. 7, the planet carrier 6 can also be designed as a lever arm or in any other way. Furthermore it is clear that the tracks shown in FIGS. 17 to 20 do not have to be configured exactly straight but can also extend along a curve. These tracks can comprise e.g. racks, chains, roller surfaces or the like which are operatively connected to planet wheels in the form of toothed wheels or friction gears. Furthermore it is clear that the power transmission ratios can be even further improved by a crank, which has a crank arm arranged parallel to the power transmission axle 12, being secured to the power transmission axle 12 etc. Finally, it goes without saying that the various features can be combined in combinations other than those described and illustrated.

1. Gearbox device, comprising: two parallel tracks (30, 31; 61, 62), which are both arranged to be moveable; at least one planet wheel (9, 63), arranged between the two tracks (30, 31; 61, 62) and operatively connected at its perimeter with the two tracks (30, 31; 61, 62); a bearing axle (10, 67) moveable parallel to the two tracks and about which the planet wheel (63) is rotatably mounted; and a power transmission axle (12, 69), the arrangement being such that, as a result of the planet wheel (9, 63) rolling along the two tracks (30, 31; 61, 62), both movements of the power transmission axle (12, 69) can be transmitted to at least one of the moveably arranged tracks (30, 31; 61, 62) and conversely movements from at least one of the moveably arranged tracks (30, 31; 61, 62) can be transmitted to the power transmission axle (12, 69) and/or the respectively other moveably arranged track (30, 31; 61, 62), characterised in that the power transmission axle (12, 69) is arranged eccentrically at the bearing axle (10, 67) or a carrier element (6) for the planet wheel (9, 63) and is moveably guided on a track (30a, 70a) which extends parallel to and at a prescribed spacing from the two moveable tracks (30, 31; 61, 62).

2. Gearbox device according to claim 1, characterized in that the bearing axle (10, 67) has a diameter which is from 0.5-1 times the value of the diameter of the planet wheel (9, 63), and in that the planet wheel (9, 63) is designed as a ring which is rotatably mounted on the bearing axle (10, 67).

3. Gearbox device according to one of claims 1 or 2, characterised in that the eccentric position of the power transmission axle (12, 69) is variable.

4. Gearbox device according to one of claims 1 to 3, characterised in that it is in the form of a planetary ear system.

5. Gearbox device according to claim 4, characterised in that the one moveably arranged track is formed by the outer perimeter of a sun wheel (1) and the other moveably arranged track is formed by the inner perimeter of a ring gear (2) of the planetary gear system.

6. Gearbox vice according to claim 4 or 5, characterised in that the bearing axle (10) is fastened to a planet carrier (6, 26) which is mounted to rotate about the central axis (4) of the planetary gear system.

7. Gearbox de according to one of claims 4 to 6, characterised in that the power transmission axle (12) is configured as a journal projecting from the bearing axle (10) and is coupled to a connecting lever (38) which sits on a drive shaft (39) mounted so as to rotate about the central axis (4) of the planetary gear system.

8. Gearbox device according to one of claims 4 to 6, characterised in that the power transmission axle is in the form of a journal (42) projecting from the bearing axle (10) and is coupled to a connecting rod (43) of a crank mechanism.

9. Gearbox device according to one of claims 4 to 8, characterised in that the ring gear (2) on the outer perimeter is in the form of a driving or driven member.

10. Gearbox device according to one of claims 4 to 9, characterised in that it contains two planetary gear systems which are coupled to one another, one of these systems being set up to drive one of the two tracks of the other planetary gear system.

11. Gearbox device according to claim 10, characterised in that the sun wheels (1, 21) of the two planetary gear systems are securely interconnected, the sun wheel (21) of a first planetary gear system being driven via the ring gear (22) of the first planetary gear system, which ring gear is driven by the second planetary gear system, and thus driving the sun wheel (1) of the second planetary gear system.

12. Gearbox vice according to claim 10 or 11, characterised in that the eccentric power axles (12, 24) of the two gear systems are arranged with their planet wheels (9, 23) lying offset by 180° behind one another or opposite one another.

13. Gearbox device according to one of claims 10 to 12 characterised in that the point of the action of force (radius on the gear system) at the power axle (12) with lever arm and journal (28, 29) at the planet wheel (9) of the first gear system is identical to the two operative connections of planet wheel (9, 23) and ring gear (2, 22) (broken line 30).

14. Gearbox device according to one of claims 10 to 13, characterised in that the central axis of the power axle (25) of the second gear system and its radius are identical to the operative connection of the planet wheel (9) and the sun wheel (1) of the first gear system (broken line 31, 34).

15. Gearbox device according to one of the preceding claims, characterised in that the power axle (12) in a crank mechanism is arranged offset by 180° on the carrier element (6).

16. Gearbox de according to one of the preceding claims, characterised in that the power axle (42) at the bearing axle (10) in a crank mechanism is arranged on the opposite side of the operative connection sun wheel/planet wheel and the main drive (high speed, low power) then takes place at the sun wheel (1).

17. Gearbox device according to one of claims 10 to 16, characterised in that the bearing axle (25) of the planet wheel (23) of the first gear system is arranged to be optionally fixed or rotatable, or is held fixed in place.

18. Gearbox cording to one of claims 1 to 3, characterised in that the two tracks (61, 62) are designed linear or arcuate.

19. Gearbox device according to claim 18, characterised in that it contains a rod-shaped guiding element (70), mounted so as to be displaceable parallel to tracks (61, 62) and coupled to the bearing axle (67) in the region of the power transmission axle (69).

20. Gearbox device according to claim 18 or 19, characterised in that, in order to avoid undesired lever actions between the guiding element (70) and the power transmission axle (69), said guiding element is mounted in bearings (71), the effective lines (70a) of which lie substantially in the same plane as the power transmission axle (69).

21. Gearbox device according to one of claims 18 to 20, characterised in that it contains at least one driving or driven gear (72, 86) which is in operative connection with a side of one of the moveable tracks (62), this side being remote from the planet wheel (63).

22. Gearbox device according to one of claims 18 to 21, characterised in that the tracks (61, 62) are configured as racks, chains, cables or roller surfaces.

23. Gearbox device according to one of claims 18 to 22, characterised in that one of the tracks (62) drives a lift or at least a driven gear (72).

24. Gearbox device according to one of claims 1 to 23, characterised in that the carrier element (6) comprises a ring, an arm or a disc.

25. Gearbox device according to one of claims 10 to 14, characterised in that the power transmission axle (25) of the second gear system is connected via a U-shaped arm (32) to a shaft (B1) which is coaxial with the gearbox axis (4).

26. Gearbox device according to one of claims 10 to 14 and 24, 25, characterised in that the power transmission axle (25) is arranged to be rotatable or fixed, or is held fixed in place.
